(19) United States
(12) Patent Application Publication
(10) Pub. No.: US 2008/0165214 A1
(43) Pub. Date: Jul. 10, 2008

(54) INK CARTRIDGE FLUID FLOW ARRANGEMENTS AND METHODS

(76) Inventor: Kenneth Yuen, San Gabriel, CA (US)

Correspondence Address: MERCHANT & GOULD PC, P.O. BOX 2903, MINNEAPOLIS, MN, 55402-0903, US

(21) Appl. No.: 11/620,452

(22) Filed: Jan. 5, 2007

(51) Int. Cl. B41J 2/195; B41J 2/175

(52) U.S. Cl. 347/7; 347/86

(57) ABSTRACT

An ink cartridge including a housing, an ink outlet, and an air vent arrangement. Some examples further include a reflector positioned within the housing. Decreasing an ink volume in the housing below a predetermined level permits a light beam directed into the housing to be reflected off from the reflector thereby indicating a low ink level. The air vent arrangement can provide a source of air into the ink reservoir at a location adjacent a bottom internal surface of the housing. Providing air to the ink reservoir at this location helps maintain a negative pressure condition in the ink reservoir that prevents ink from unintentionally dripping out of the ink cartridge prior to mounting the cartridge to a printer. The air vent arrangement includes a one-way valve and an air channel that provides air to the one-way valve from an inlet that is positioned on the housing vertically above the one-way valve.

### FIELD OF THE INVENTION

The present invention generally relates to ink containers for ink jet printers, and more specifically relates to ink flow and air flow arrangements for ink jet printer ink cartridges.

### BACKGROUND OF THE INVENTION

Ink jet printers are a popular form of printer used with computers and similar applications involving document printing or graphics preparation. Typical ink jet printers have replaceable ink cartridges. Different styles of ink cartridges have different ink flow arrangements. One ink flow arrangement includes a sealed ink chamber, wherein the ink chamber walls are flexible in order to be depressed under vacuum pressure conditions that are generated as ink flows out of the ink chamber. In this arrangement, a biasing force is sometimes applied to the ink chamber walls to ensure initiation of ink flow out of the cartridge. Another ink flow arrangement includes an ink chamber that is in air flow communication with an exterior of the ink chamber so that the ink maintains an internal atmospheric pressure condition. In this arrangement, air is drawn into the ink chamber as ink flows out of the ink chamber.

A common issue in many ink cartridges is the tendency for ink to drip out of the ink outlet when the ink cartridge is not mounted in the ink jet printer. One solution for this problem is to add an ink absorbing material such as a foam product inside the ink chamber. The foam reduces ink pressure at the ink outlet thereby reducing incidence of undesired dripping ink. A related issue is the tendency for ink to overflow out of the ink outlet junction with the ink jet printer or out of the print head of the printer when the ink cartridge is mounted to the printer. The overflow of ink at the junction or the print head typically results from uncontrolled or excessive ink flow out of the ink outlet. The overflowing ink can damage the printer and cause printing problems during use of the printer.

A further issue related to ink cartridges is monitoring the ink level in the ink chamber. Of particular importance is the ability to communicate a low ink level to the printer so the printer can stop printing before the print head of the printer does not run dry of ink.

### SUMMARY OF THE INVENTION

The present disclosure relates to various ink flow and air flow configurations and methods for an ink jet printer ink cartridge. An example ink cartridge includes a housing, an ink outlet, and an air vent arrangement. Some examples further include a reflector positioned within the housing. The housing defines an ink reservoir for holding a supply of ink. The reflector includes a reflective surface used to reflect light from a light source. The reflector is movable within the ink reservoir. A position of the reflector, as determined by light being reflected off of the reflective surface, corresponds to an ink level or ink volume in the ink reservoir. The reflective surface can include a concave structure. The reflective surface typically faces generally downward in the ink reservoir in a direction facing a light source positioned in a printer to which the ink cartridge is mounted. The air vent arrangement can provide a source of air into the ink reservoir at a location adjacent a bottom internal surface of the ink reservoir. Providing air to the ink reservoir at this location helps maintain a negative pressure condition in the ink reservoir that prevents ink from unintentionally dripping out of the ink cartridge prior to or after mounting the cartridge to a printer. A one-way valve is positioned on an end of the air vent arrangement to prevent ink from passing from the ink reservoir into the ink vent. An air channel provides air to the one-way valve from an inlet that is positioned on the housing vertically above the one-way valve. The air channel can be positioned within the ink reservoir or along an exterior surface of the housing.

The above summary is not intended to describe each disclosed embodiment or every implementation of the inventive aspects disclosed herein. Figures in the detailed description that follow more particularly describe features that are examples of how certain inventive aspects may be practiced. While certain embodiments are illustrated and described, it will be appreciated that the invention/inventions of the disclosure are not limited to such embodiments.

### BRIEF DESCRIPTION OF THE DRAWINGS

FIG. 1 is a schematic perspective view of an example ink cartridge in accordance with the inventive principles disclosed herein;

FIG. 2 is a schematic side view of the ink cartridge shown in FIG. 1;

FIG. 3 is a schematic front view of the ink cartridge shown in FIG. 1;

FIG. 4 is a schematic rear view of the ink cartridge shown in FIG. 1;

FIG. 5 is a schematic bottom view of the ink cartridge shown in FIG. 1;

FIG. 6 is a schematic cross-sectional view of the ink cartridge shown in FIG. 4 taken along cross-sectional indicators 6-6;

FIG. 7 is a schematic top view of the ink cartridge shown in FIG. 1 with a portion of the top cover of the housing removed to show the light reflective member;

FIG. 8A and 8B are schematic cross-sectional views of the ink cartridge shown in FIG. 2 taken along cross-sectional indicators 8A,B-8A,B, and illustrate the light reflective member at different heights in the cartridge housing;

FIG. 9 is a schematic side view of another example ink cartridge in accordance with the inventive principles disclosed herein;

FIG. 10 is a schematic front view of the ink cartridge shown in FIG. 9;

FIG. 11 is a schematic rear view of the ink cartridge shown in FIG. 9;

FIG. 12 is a schematic bottom view of the ink cartridge shown in FIG. 9;

FIG. 13 is a schematic top view of the ink cartridge shown in FIG. 9 with a portion of the top cover of the housing removed to show the light reflective member;

FIG. 14 is a schematic cross-sectional view of the ink cartridge shown in FIG. 11 taken along cross-sectional indicators 14-14;

FIG. 15A and 15B are cross-sectional views of the ink cartridge shown in FIG. 9 taken along cross-sectional indicators 15A, B-15A, B, and illustrate the light reflective member at different heights in the cartridge housing;

FIG. 16 is a schematic side perspective view of a body portion of the cartridge housing illustrating features in the ink reservoir;

FIG. 17 is a schematic side cross-sectional view of another example ink cartridge in accordance with the present disclosure, the ink cartridge including a reflector positioned above a bottom surface of the cartridge housing.

FIG. 18 is a schematic side perspective view of another example ink cartridge in accordance with the present disclosure, the ink cartridge including a plurality of ink outlets and a plurality of air inlets;

FIG. 19 schematically illustrates the ink cartridge shown in FIG. 18 with a seal member removed to expose portions of the ink inlets;

FIG. 20 is a schematic side perspective view of an opposing side of the ink cartridge shown in FIG. 18;

FIG. 21 is a schematic partially exploded bottom perspective view of the ink cartridge shown in FIG. 18 with the wick portions of the ink outlets removed;

FIG. 22 is a schematic partially exploded side perspective view of the ink cartridge shown in FIG. 18 with a cover member separated from a body portion of the cartridge housing;

FIG. 23 is a schematic top perspective view of view of another example ink cartridge in accordance with the present disclosure;

FIG. 24 is a schematic bottom perspective view of the ink cartridge shown in FIG. 23;

FIG. 25 is a cross-sectional side view of the ink cartridge shown in FIG. 23;

FIG. 26 is a schematic top perspective view of view of another example ink cartridge in accordance with the present disclosure;

FIG. 27 is a schematic bottom perspective view of the ink cartridge shown in FIG. 26; and

FIG. 28 is a cross-sectional side view of the ink cartridge shown in FIG. 26.

While the inventive aspects of the present disclosure are amenable to various modifications and alternate forms, specific embodiments thereof have been shown by way of example in the drawings, and will be described in detail. It should be understood, however, that the intention is not to limit the inventive aspects to the particular embodiments described. On the contrary, the intention is to cover all modifications, equivalents, and alternatives falling within the spirit and scope of the inventive aspects.

### DETAILED DESCRIPTION

The present disclosure relates to replaceable ink containers that provide ink to an ink jet printer. The ink container, also referred to as an ink cartridge, includes a housing that defines an ink reservoir, an air vent in air flow communication with the ink reservoir, and an ink outlet in ink flow communication with ink reservoir. The air vent extends into the ink reservoir and provides a one-way air inlet into the ink reservoir near a bottom internal surface of the ink reservoir.

Another aspect of the present disclosure relates to an ink level indicator positioned within the ink reservoir. The ink level indicator includes a reflector member that reflects a light beam when an ink level in the ink reservoir reaches a depleted state. The reflective member can include a concave reflective surface for reflecting the light beam. The reflective member can be configured to float in the ink held in the ink reservoir. A floating position of the reflective member can correspond to an amount of ink remaining in the ink reservoir.

As used herein, the terms printer ink cartridge, ink cartridge, printer cartridge, and cartridge generally refer to an ink cartridge for an ink jet printer. As used herein, the term “reflector” is defined as a body or surface that reflects light or other radiation such as radio frequency and ultrasound waves. The term “concave“as used herein means a structure that is hollowed or rounded inward.

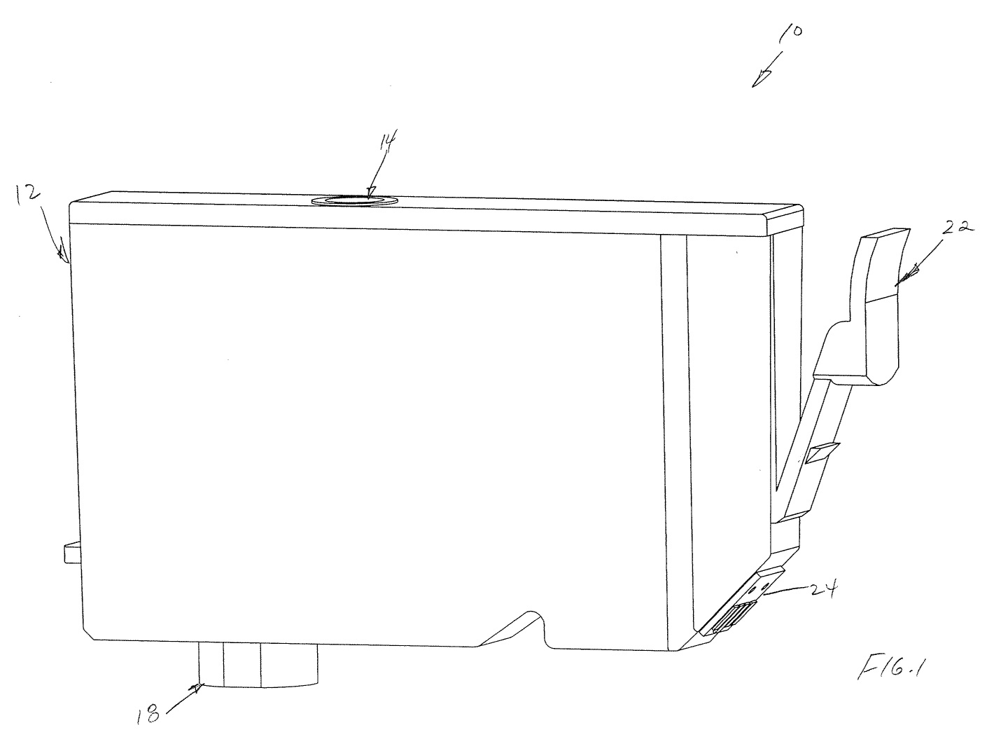

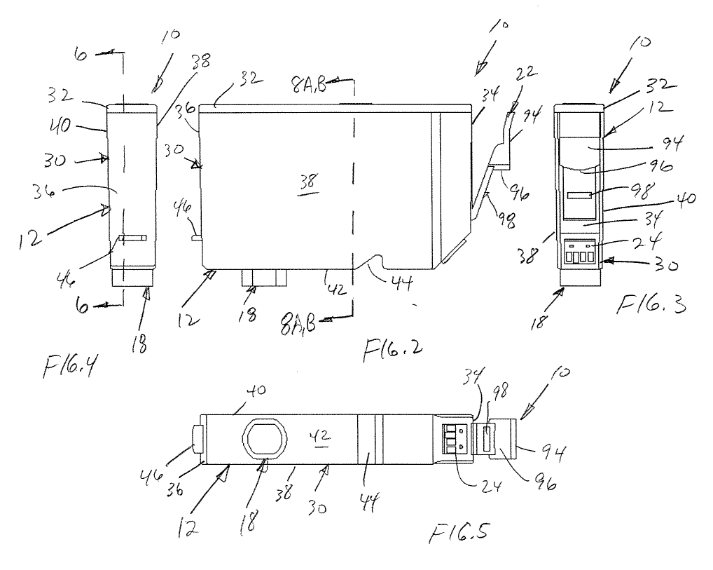

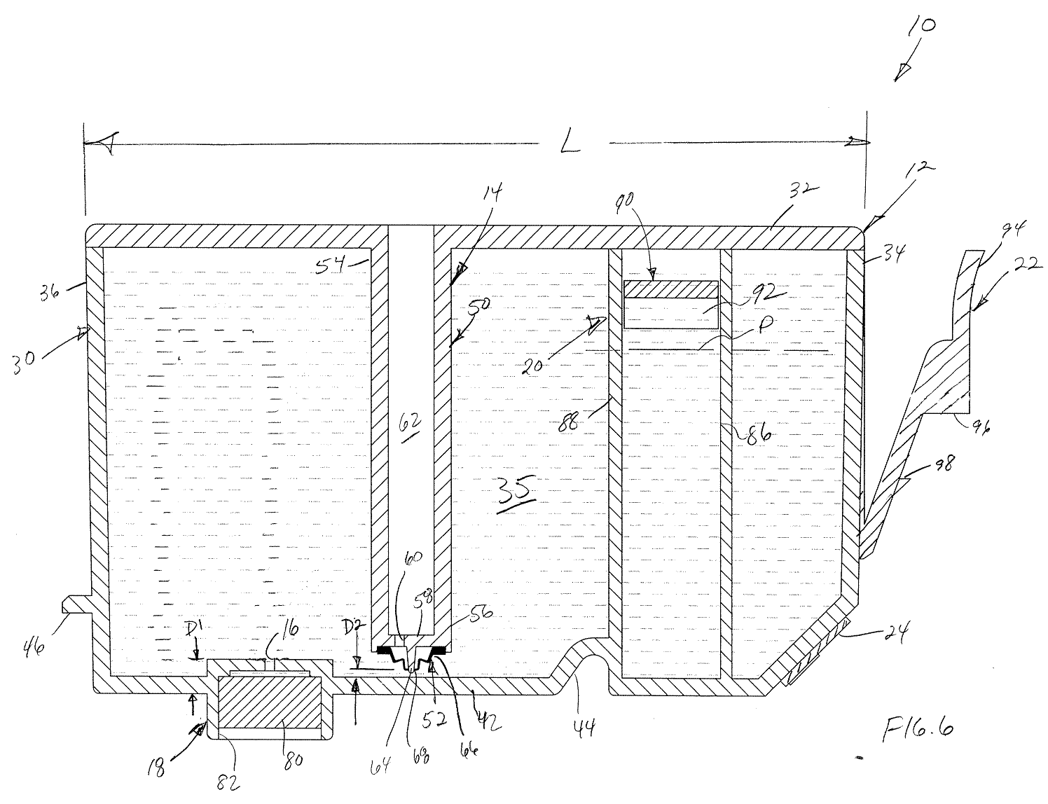

### EXAMPLES OF FIGS. 1-8B

Referring now to FIGS. 1-8B, an example cartridge assembly 10 is shown and described. Cartridge assembly 10 includes a housing 12, an air vent 14, an ink outlet 18 having an ink channel 16, an ink level indicator 20, a handle 22, and a chip 24. The housing 12 includes a base 30 and a top cover 32 that together define an ink reservoir 35 configured to hold a supply of ink. The base 30 includes front, rear, and first and second sides 34, 36, 38, 40 that define a peripheral side wall of the housing 12. The base 30 further includes a bottom wall 42 that extends along a length of the base 30 in engagement with a bottom portion of the sides 34, 36, 38, 40. A top side of the wall 42 defines an inner bottom surface of the ink reservoir 35. A latching groove 44 is defined in the bottom wall 42 at a location between the front and rear sides 34, 36. The latching groove 44 can be used to help retain the cartridge assembly 10 within a printer cartridge bay. A latch 46 is positioned on the rear side 36. The latch 46 can also be used to help retain the cartridge assembly 10 in a printer cartridge bay.

The cartridge assembly 10 can be locked into place in a printer cartridge bay by inserting the rear side 36 within the cartridge bay (not shown) with the latch 46 engaging a recess or protrusion within the bay. The cartridge assembly 10 is then rotated downward into the bay until a latching feature of the printer that is aligned with the front side 34 is engaged between top and bottom latch surfaces 96, 98 of the handle 22. Releasing the cartridge assembly from the printer cartridge bay can be done by pressing the engagement portion 94 of the handle 22 towards the front side 34 to release the handle from the latching structure of the printer. After releasing the handle, the front side 34 can be rotated up and the cartridge assembly 10 removed.

The air vent 14 includes an air duct 50 and a valve 52. The air duct 50 includes an upper end 54 that terminates at the top cover 32. The upper end 54 is open to atmosphere air. The air duct 50 also includes a lower end 56 and a bottom wall 58 extending generally perpendicular to the direction of extension of the air duct 50 from the top cover 32 towards the bottom wall 42. An air opening 60 is defined in the bottom wall 58 to provide air flow communication through the bottom wall 58 and into an air channel 62 defined within the air duct 50.

The air vent 14 further includes a valve 52 mounted to the lower end 56 of the air duct 50. The valve 52 includes a post 64 extending generally downward from the bottom wall 58, and a diaphragm 66 also mounted to the bottom wall 58. The diaphragm 66 includes a diaphragm opening 68 sized to receive a distal end of the post 64. The diaphragm 66 can comprise a flexible, deformable material that is resistant to being damaged from exposure to ink. Some example materials to diaphragm 66 include rubber and silicone. The diaphragm can comprise a relatively thin construction that is deformable under typical vacuum pressure conditions in the ink reservoir. Other structural features of the diaphragm such as the number and angle of folds or bends in addition to the thickness of the diaphragm can be varied to control how the diaphragm changes shape relative to post 64 under vacuum pressure conditions. In one example, the diaphragm has a maximum diameter of about 3 mm to about 10 mm, and more preferably about 5 mm to about 7 mm. The opening 68 typically has a diameter of about 0.2 mm to about 3 mm, and more preferably about 0.5 mm to about 1 mm.

The post 64 includes a taper along its length. Alternatively, the taper on post 64 is located at its distal end. A diameter of the post 64 at the base of the post next to bottom wall 58 is greater than a diameter of the diaphragm opening 68, and the diameter of the post 64 at a distal end is less than a diameter of the opening 68. An air gap is provided between the post 64 and the diaphragm opening 68 as the diaphragm 66 moves up and down relative to the post 64 (see FIG. 6). Alternatively, the post 64 has a constant diameter along its length and the valve opens when the diaphragm opening 68 is pulled away from the post 64 under vacuum pressure conditions in the ink reservoir.

The valve 52 acts as a one-way air valve to provide air at atmospheric pressure into the ink reservoir 35 near the bottom wall 42. As will be described in further detail below, the diaphragm opening 68 remains in a closed, sealed state against the post 64 until a reduced pressure condition within the ink reservoir 35 greater than a threshold negative pressure level draws the diaphragm 66 at the diaphragm opening 68 away from the post 64 to permit air flow into the ink reservoir. When the valve 52 is open, air from outside of the housing 12 travels through the channel 62 and air opening 68 into the diaphragm 66. The air then moves through the diaphragm opening 68 into the ink reservoir 35. The threshold negative pressure level is typical greater than about 0.25 atmospheres and less than about 5 atmospheres. The one-way diaphragm valve 52 can be replaced in alternative arrangement with different types and styles of one-way or other valves that provide the desired air flow into the ink reservoir 35.

The air duct 58 of the air vent 14 is shown in FIG. 6 as being integrally formed with the top cover 32. Such a configuration may be advantageous for several reasons including, for example, reduction of the number of parts, elimination of assembly steps, and ensuring a sealed connection between the top cover and air duct 50. In alternative arrangements, the air vent 14 can be manufactured as a separate piece that is later secured to an aperture defined in the top cover 32. In still further arrangements, the air vent 14 can be coupled to other sides of the housing 12 such as, for example, one of the rear, first, or second sides 36, 38, 40.

The ink channel 16 is positioned along the bottom wall 42. In one example arrangement, the inlet channel 16 is typically positioned a distance D1 within about 10 mm from the bottom wall 42, and preferably about 0 to about 4 mm from the bottom wall 42. A distance of the diaphragm opening 68 can have a spacing D2 of greater than 0 mm and up to about 10 mm from the bottom wall 42 when in a rest position. A rest position is defined as a position of the diaphragm before application of a negative or positive pressure condition within the ink reservoir 35 that exceeds the threshold pressure condition that moves the diaphragm away from the post 64.

A position of the ink channel 16 can also be defined relative to a position of the air inlet defined by the diaphragm opening 68. For example, the ink channel 16 can be spaced from the bottom wall 42 a distance D1 within about 100% to about 200% of a distance D2 between the diaphragm opening 68 and the bottom wall 42. The position D1 of ink channel 16 relative to the bottom wall 42 and the position D2 of the diaphragm opening 68 can be at substantially the same vertical position relative to the bottom wall 42.

The ink outlet 18 includes a wick 80 positioned within a wick recess 82. The wick recess 82 is defined in the bottom wall 42 of the housing 12. The ink is absorbed by the wick 80 in the ink recess 82. Ink held by the wick 80 is transferred to the printer when the cartridge assembly 10 is mounted to the printer.

The ink outlet 18 can have different structure in other arrangements while providing a similar function of transferring ink from the cartridge 10 to the printer. For example, the wick recess 82 is maintained outside of the housing 12 and does not protrude into the ink reservoir as does the recess 82 shown in FIG. 6. In still further examples, the wick recess is formed in a separate piece that is positioned within an aperture defined in the bottom wall 42 or otherwise secured to the cartridge housing 12. In still further arrangements, the wick 80 is replaced with an alternative structure such as a plug or seal member that comprises, for example, a self-sealing structure or material such as rubber.

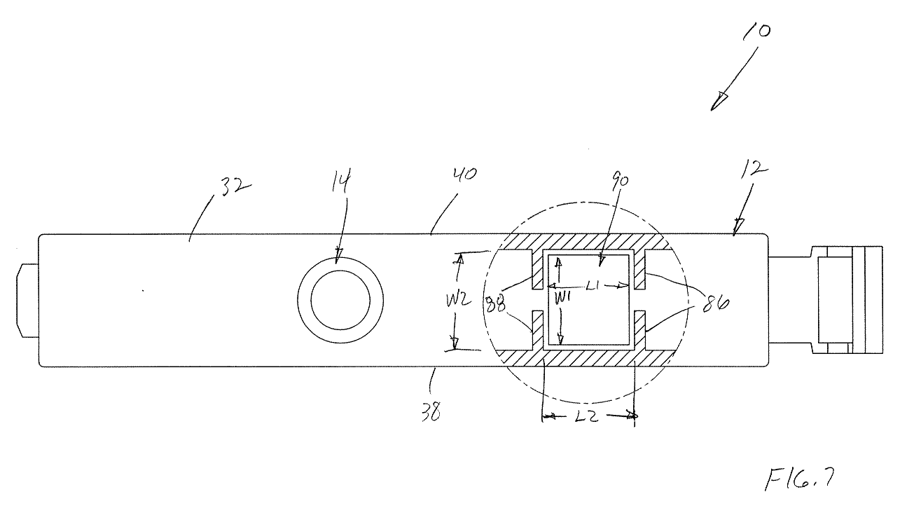

The ink level indicator 20 is shown and described with reference to FIGS. 6-8B. The ink level indicator 20 includes first and second sets of channel members 86, 88 (see FIGS. 6 and 7). The channel members extend in a perpendicular direction into the ink reservoir 35 from the first and second sides 38, 40. A gap is defined between the first set of channel members 86 and a separate gap is defined between the second set of channel members 88. The gaps define an ink flow path through the ink level indicator 20.

Ink level indicator 20 further includes a floating reflector 90 (also referred to as a floating concave reflector (“FCR”)) having a concave surface 92. The FCR 90 floats in the ink held in ink reservoir 35. In one example, the flotation of FCR 90 results from the material density of FCR 90 being less than the density of the ink. Depending on the density of the material used in the FCR 90, the FCR can maintain different maximum and minimum heights relative to the top cover 32 and bottom wall 42. For example, the FCR 90 when comprising a more dense material can rest upon the bottom wall 42 when an ink level in the ink reservoir 35 is still maintained above an upper surface of the FCR 90. In other examples, when the FCR 90 includes a less dense material, the FCR 90 may not contact the bottom wall 42 until the ink level has receded below a top point of the concave surface 92.

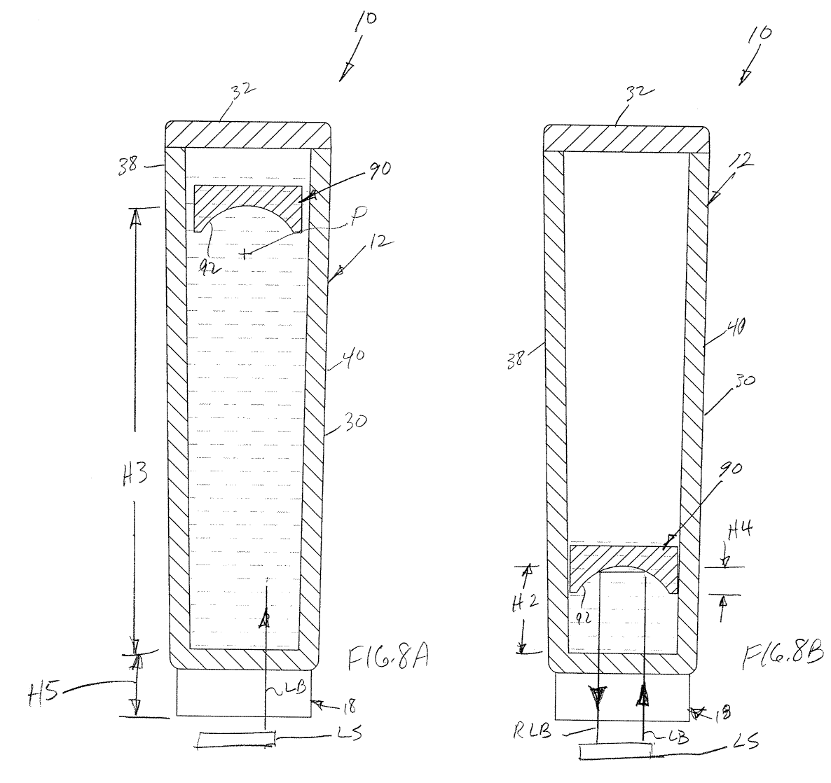

The concave surface 92 curves about an axis P (see FIGS. 6 and 8A) that is aligned parallel with a longitudinal direction of the housing 12 (along length L shown in FIG. 6). That is, the axis about which the concave surface 92 curves is aligned with a direction extending between the front and rear sides 34, 36. In other embodiments, the axis of the concave surface 92 can be arranged in different orientations such as, for example, extending perpendicular to the longitudinal dimension L of the housing 12. A concave surface is not required to provide reflection of a light beam or other type of signal from the FCR 90. In some examples, the concave surface 92 can be replaced with a generally flat surface having reflective properties. Other structures such as a polygonal structure having multiple planar surfaces can also be used in place of the concave surface 92. Furthermore, the reflective surface of the FCR 90 can be on the opposite side of the FCR 90 from that surface facing the source of light. In some cases, the type of ink being used may affect the reflective properties of a given reflective structure.

The FCR 90 can comprise multiple layers of material. In one example, the FCR 90 includes a block of material having a concave surface 92 formed therein. A separate layer of reflective material is mounted to the concave surface 92 to provide a reflective property for the FCR 90. In other examples, the FCR 90 is made from a block of reflective material such that when the concave surface 92 is formed therein the concave surface 92 is automatically reflective. Some example reflective materials include silver that is applied by painting, plating, or as a foil. Alternatively, the entire FCR 90 comprises a metal material such as silver that includes a polished, reflective surface and air chambers that promote floatation.

Two important aspects of the material used for the FCR 90 is that the material must be buoyant and float in the type of ink held in the ink reservoir. The material for FCR 90 should not have any adverse interactions with the ink (e.g., chemical reaction that results in corrosion, pitting, etc.). Some example materials that meet these requirements include polypropylene (PP) and polyethylene (PE), which has inert properties The ink level indicator 20 is shown including two sets of channel members 86, 88 that capture the FCR 90 in the longitudinal dimension of the housing 12. The first and second sides 38, 40 of the housing 12 retain the FCR in the transverse dimension of the housing 12. In order to minimize the instance of the FCR 90 getting stuck or bound against any of the members 86, 88, 38, 40 while moving up and down as the ink level changes in the ink reservoir 35, the FCR includes generally non-planar surfaces on all four sides. For example, the sides of the FCR 90 can be slightly tapered or rounded with a concave or convex curvature to permit easier downward movement in the channel by minimizing the surface contact area. Further, the length L1 and width W1 of the FCR from the top or bottom profile (e.g., see FIG. 7) must be less than the corresponding channel length L2 and width W2 defined by the features 86, 88, 38, 40. In one example, the area dimension (L1×W1) of the FCR as shown in FIG. 7 is about 80% to about 95% of the area of the channel (L2×W2) defined by features 86, 88, 38, 40. The tolerances between the size of the FCR 90 and the internal dimension of the channel ensure that no tumbling or rotation of the FCR 90 occurs as FCR 90 moves vertically in the channel.

Operation of the ink level indicator 20 is described further with reference to FIGS. 8A and 8B. When the ink reservoir 35 is substantially filled with ink, the FCR 90 floats near to the fill line of ink in the ink reservoir. FIG. 8A illustrates the FCR 90 at a raised position wherein a peak of the concave surface 92 is positioned at a height H3 relative to the bottom internal surface of the ink reservoir 35 defined by the bottom wall 42. When in the raised position shown in FIG. 8A, a significant amount of ink is positioned between the concave surface 92 and a source of light (“LS”) positioned below the bottom wall 42. The source of light is typically provided in the printer to which the cartridge assembly 10 is attached during use. The light source is typically part of a transceiver device that transmits light and is capable of receiving reflected portions of that transmitted light. The transceiver may be configured such that when reflected light is received back at the transceiver, the transceiver indicates a low ink level within the ink reservoir 35.

In the arrangement shown in FIG. 8A, a light (“LB”) is transmitted from the light source LS into the ink's reservoir 35 through the bottom wall 42. The bottom wall 42 can comprise a light transmissive material that permits the light beam LB to pass therethrough without changing the light path or decreasing the intensity of the light beams passing through the material. When the light beam enters the ink reservoir 35, the light beam LB is dissipated within the ink after traveling a certain distance vertically into the ink reservoir 35. None of the light beam LB is reflected back to the light source LS until the FCR 90 position is lowered sufficiently to permit reflection of the light beam LB back to the light source LS.

FIG. 8B illustrates the FCR 90 in a lowered position at a height H2. At the height H2, the amount of ink between the concave surface 92 and the light source LS is sufficiently reduced such that the light beam LB can be reflected off from the concave surface 92 back as a reflective light beam (“RLB”) to the light source LS. While some of the reflective light beam RLB may be dispersed within the ink after being reflected off of the concave surface 92, at least a portion of the RLB must be passed through the bottom wall 42 in order to be received by the light source LS. The light source LS may be configured such that a property of the reflected light RLB such as the intensity or amount of the RLB is used to determine an amount of ink in the ink reservoir. In some cases, the reflected light RLB must have a property that surpasses a threshold level before the light source LS generates a signal that a low ink condition exists in the ink reservoir 35.

A low signal can be used by the printer to automatically shut down the printer after a certain number of additional prints has occurred after the low ink signal is generated. In this way, the printer can ensure that at least some ink remains in the ink cartridge (e.g., at the ink outlet 18) and available to the print head of the printer when the user is required to replace the ink cartridge.

The height H2 is preferably at least as great as the height H4 of the concave surface 92. In one example, the height H4 is about 0 mm to about 4 mm and the height H2 is about 0 mm to about 6 mm.

Many factors can influence the reflection from the FCR 90 and detection of light reflected out of the ink cartridge 10 by the FCR 90. For example, the type of material used on the surface 92, the structure of the surface 92, the smoothness (or roughness) characteristics of the reflective surface of the FCR 90, the type of ink retained in the ink reservoir, and the housing material through which the light beam travels into and out of the ink cartridge are all influential factors. Typically, the total distance from the light source and the reflective surface of the FCR 90 is not an important factor in determining the ink level of the ink cartridge. In some cases, the total distance from the light source to the reflective surface of the FCR 90 is an important consideration. A bottom or leading surface of the ink outlet 18 usually defines a lowest most point of the ink cartridge 10, and therefore can serve as a reference point for a height measurement H5 (see FIG. 8A) used to determine a distance between the light source and a bottom wall of the housing body 30 upon which the FCR 90 rests. The value of H5 is typically about 0 mm to about 15 mm, and more preferably about 5 mm to about 12 mm.

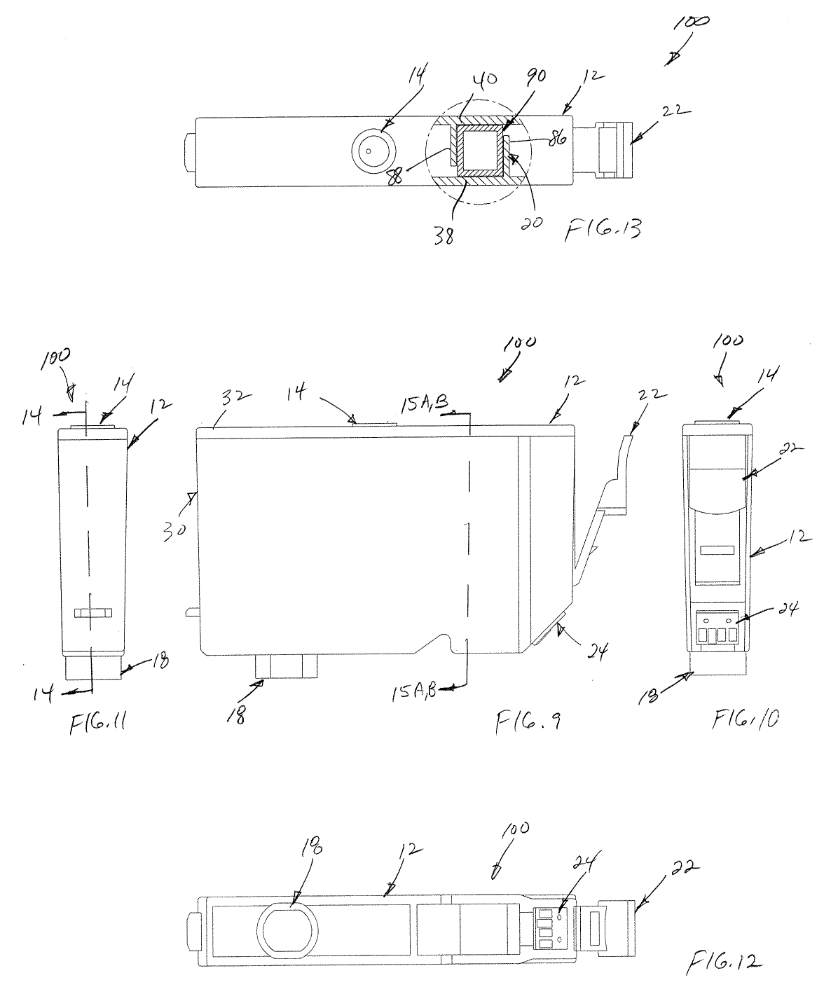

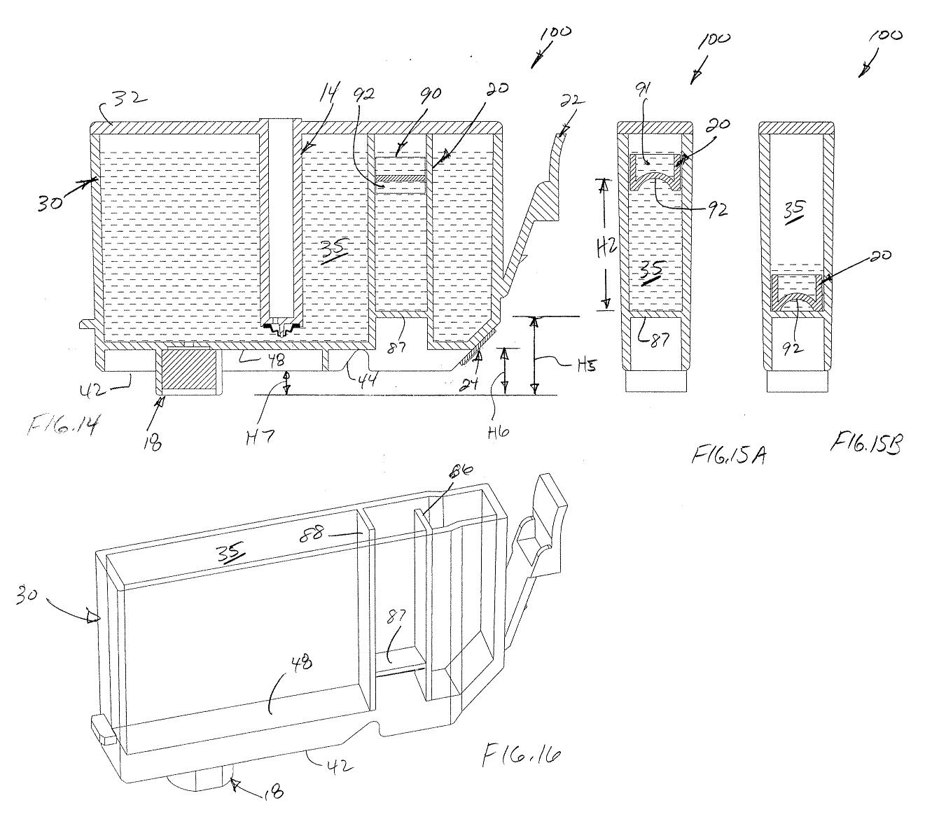

### EXAMPLE OF FIGS. 9-16

Referring now to FIGS. 9-16, another example cartridge assembly 100 is shown and described. Cartridge assembly 100 includes many of the same features and reference numbers as described related to cartridge assembly 10. Cartridge assembly 100 includes an ink level indicator 20 having an alternative configuration for the first and second channel members 86, 88, the floating concave reflector (FCR) 90, and the concave surface 92 of the reflector 90. The features at the bottom side of the base 30 of the housing 12 are also modified as compared to the example 10 described with reference to FIGS. 1-8B.

Referring to FIGS. 13-16, the ink level indicator 20 includes first and second channel members 86, 88 extending from opposing sides 38, 40 of the housing base 30. The channel members 86, 88 define a channel within which the FCR 90 moves. A channel bottom wall 87 upon which the FCR 90 rests when the ink level is depleted is positioned vertically raised relative to a reservoir bottom wall 48 (see FIG. 14). The channel bottom wall 87 is positioned at a height H5 relative to a bottom-most leading surface of the ink outlet 18. The height H5 is greater than a height H6 of the reservoir bottom wall 48 relative to the ink outlet 18, and also greater than a height H7 from the bottom wall 42 of the base 30 relative to the ink outlet 18. The height H5 is typically in the range of about 3 mm to about 15 mm, and more preferably 5 mm to about 12 mm.

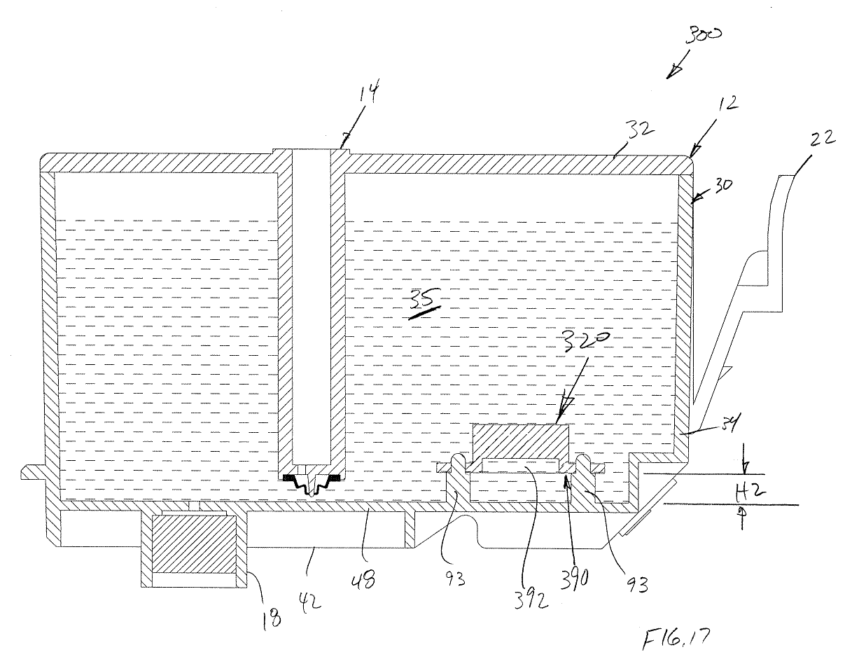

The FCR 90 includes the concave surface 92 at a bottom side thereof and defines a cavity 91 accessible from a top side thereof (see FIG. 15A). The size of cavity 91 and the overall amount of material included in the FCR 90 can be varied to change the floatation properties and performance of the FCR 90 given the different inks in which the FCR 90 floats.

The size and shape of the concave surface 92 can be altered to change the reflection characteristics and performance for the FCR 90. For example, the radius, width and height of the surface 92 can be changed (e.g., the surface 92 can be made substantially planar). Alternatively, the surface 92 can include a plurality of planar surfaces angled relative to each other, or can include other structures and shapes different from a concave shape having the radius shown in FIGS. 15A, B. Other portions of the FCR 90 can be shaped differently from that configuration shown in FIGS. 9-16. For example, the generally square-shaped horizontal cross section shown in FIG. 13 can modify to include more or fewer sides to provide, for example, a triangular or pentagon cross sectional shape. The shape and size of the channel members 86, 88 could be modified to match the horizontal cross sectional shape of the FCR 90.

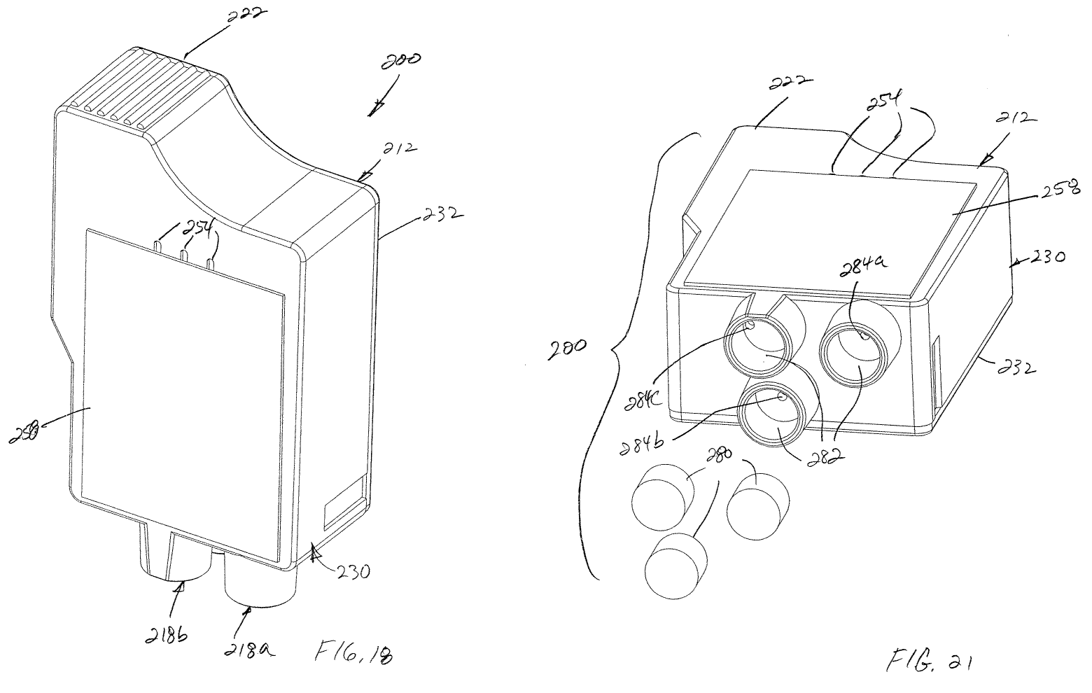

As mentioned above, the channel bottom wall 87 is spaced vertically above the reservoir bottom wall 48 and bottom wall 42 of the base 30. FIG. 16 illustrates this elevated position of channel bottom wall 87. When the FCR 90 is resting against the channel bottom wall 87 (i.e., the lowest point in the reservoir 35 when the FCR 90 could reflect light), there is a volume of ink remaining in the reservoir 35. Thus, there is always a portion of ink remaining in the ink reservoir 35 when the printer receives a signal that the ink volume in the cartridge 100 is empty or near empty (i.e., when light is reflected back from the FCR 90). The position of channel bottom wall 87 helps ensure that ink supply in the cartridge 100 does not expire before the printer automatically shuts down printing after receiving the low ink signal.

The relative spacing between channel bottom wall 87 and reservoir bottom wall 48 can be modified depending on a number of considerations to ensure the ink supply in reservoir 35 does not expire before the printer stops printing pages. For example, the configuration of reflective surface 92, the light transmissive properties of the channel bottom wall 87, and the spacing H5 related to a spacing between the FCR 90 and the light source can all considerations when defining a position of the wall 87 and the design of the reservoir 35 generally.

### EXAMPLE OF FIG. 17

FIG. 17 illustrates an additional ink level indicator configuration 320 in a cartridge assembly 300. The ink level indicator 320 includes a reflector 390 that is pre-positioned vertically spaced above the reservoir bottom wall 48. The reflector 390 includes a reflective surface 92, which in this arrangement is preferably a concave reflective surface. The reflector 90 is supported by standoff support members 93 that fix the position of reflector 390 at a height H2 above the reservoir bottom wall 48. Typically, the height H2 is sufficient to provide a volume of ink between the reflector 390 and the light source when the ink level is at least at the height H2 such that a light beam directed through the reservoir bottom wall 48 toward the reflector 390 cannot be reflected back.

The ink level indicator 320 is operable to indicate a low ink level in the cartridge assembly 300 when the ink level decreases below the height H2. The further the ink level decreases below H2, the greater the likelihood that the light beam being directed towards the reflector 90 can pass through the ink, reflect off from reflective surface 92, and pass back through the ink towards the light receiver positioned on the printer. Once a reflected light signal is received, a low ink signal is generated for the printer controls and printing is automatically shut off after a pre-determined amount of printer use is completed (e.g., number of pages printed).

The reflector 390 is shown supported on the reservoir bottom wall 48 in this arrangement. In other arrangements, the reflector 390 can be supported from other surfaces or structures of the cartridge assembly 300. For example, the reflector 390 can be supported from support members extending vertically downward from the top cover 32 of the housing 12. In another arrangement, the reflector 390 can be supported from the front wall 34 or either of the opposing sidewalls (e.g., sides 38, 40 shown in FIG. 13). Maintaining the reflector 390 at a location spaced above the reservoir bottom wall 48 through which the light beam is directed while still permitting a volume of ink to exist between the FCR 390 and wall 48 that is in fluid communication with the ink outlet 18 can be achieved in many different ways.

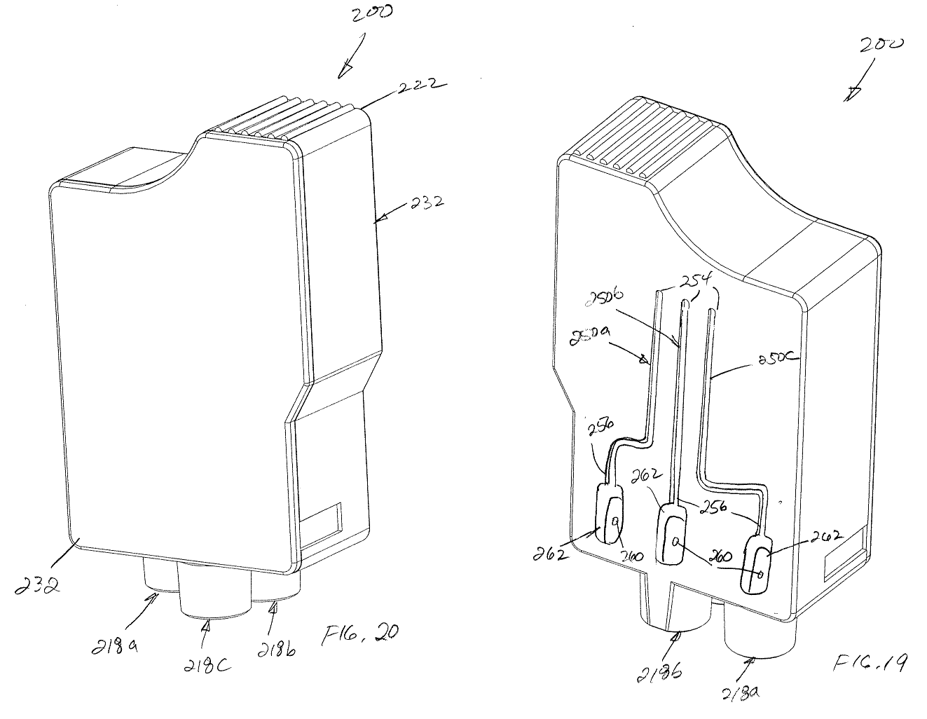

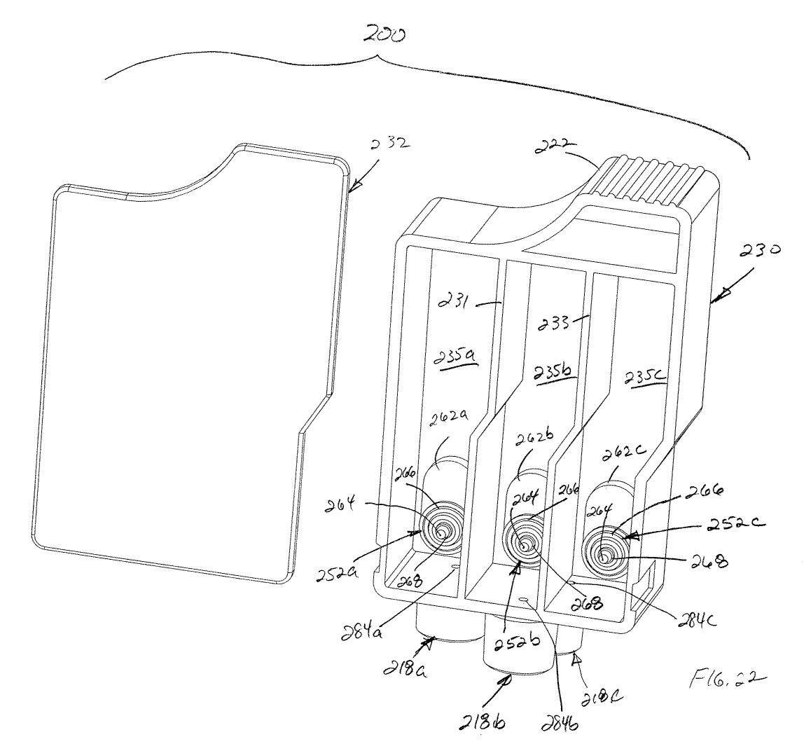

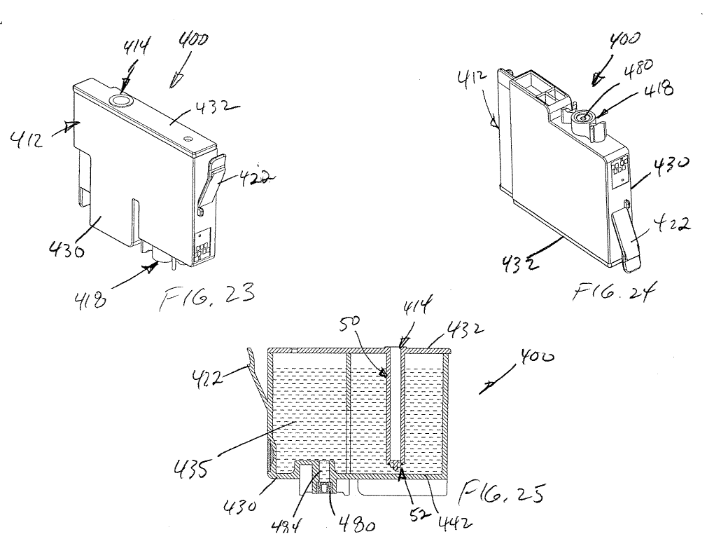

### EXAMPLE OF FIGS. 18-22

Referring now to FIGS. 18-22, another example cartridge assembly 200 is shown and described. Cartridge assembly 200 includes a housing 212, an air vent arrangement 214, a plurality of ink outlets 218A-C, and a handle 222. The housing 212 includes a base 230 and a cover 232. A plurality of partitions 231, 233 are positioned within the base 230. The partitions 231, 233 help define a plurality of ink reservoirs 235A-C when the lid is sealed closed against the base 230 and the partitions 231, 233. Each of the ink reservoirs 235A-C is associated with one of the ink outlets 218A-C.

Each of the ink outlets 218A-C includes one of the ink apertures 284A-C that provides ink flow communication with one of the ink reservoirs 235A-C. Each of the ink outlets 218A-C also includes a wick recess 282 into which a wick 280 is positioned (see FIG. 21).

The air vent arrangement 214 provides a source of air to each of the ink reservoirs 235A-C in a way that provides a negative pressure condition within the ink reservoirs 235A-C. Maintaining a negative pressure condition within the ink reservoirs 235A-C is helpful for reducing incidence of unintentional dripping of ink from the ink outlets 218A-C before mounting the cartridge assembly 200 to a printer, and for reducing excessive ink outflow to the printer when the cartridge assembly 200 is mounted to a printer that cause dripping at the print head of the printer. The air vent arrangement 214 includes a plurality of air duct channels 250A-C, each having an upper end 254 and a lower end 256. The lower end 256 is coupled in fluid communication with one of the air chambers 262A-C. The air chambers 262A-C are typically positioned along a bottom portion of the housing base 230. One of the air openings 260A-C is associated with each of the air chambers 262A-C. The air openings 260A-C provide air flow communication from the chambers 262A-C to a plurality of valves 252A-C associated with the ink reservoirs 235A-C.

Each of the valves 252A-C includes a post 264, a diaphragm 266, and a diaphragm opening 268. A rear surface of the diaphragm encloses the air openings 260A-C similar to how the air valve 52 covers the air opening 60 in the cartridge assembly 10 shown in FIG. 6. An opposing front surface of the diaphragm is exposed to ink in the ink chambers 235A-C. Each of the valves 252A-C includes a post 264, a diaphragm 266, and a diaphragm opening 268. The diaphragm opening 268 is aligned with the post 264. When a negative pressure condition within the reservoirs 235A-C is below a threshold level, the diaphragm 266 remains in contact with the post 264 to seal shut the diaphragm openings 268. As the negative pressure condition in the reservoirs 235A-C increases above the threshold amount, which pressure condition is caused by removal of ink through the ink outlets 218A-C, the diaphragm 266 moves axially away from the post 264 thereby permitting air to pass from the chambers 262A-C, through the air openings 260A-C and the diaphragm opening 268, and into the reservoirs 235A-C.

On the outside of the housing 212, the air channels 250A-C and chambers 262A-C are covered by a cover or sealing member 258. The seal is sized to provide and is configured to provide an airtight seal around all portions of the air duct 250A-C and chambers 262A-C except for the upper ends 254 of the channels 250A-C. As shown in FIG. 18. The air vent arrangement 214 provides an air flow path from the upper end 254 on an upper outside portion of the housing 212 to a bottom area within the reservoirs 235A-C via the diaphragm opening 268. The air vent arrangement 214 provides one-way air flow into the ink reservoirs 235A-C that helps maintain a pressure condition within the cartridge assembly 200 that prevents or at least significantly reduces the incidence of inadvertent drip out of the ink outlets 218A-C before mounting the cartridge assembly to a printer, while still providing sufficient airflow into the reservoirs 235A-C that permits the outflow of ink from the ink outlets 218A-C as ink is drawn from the ink cartridge assembly 200 when the cartridge assembly is mounted to a printer.

The air vent arrangement 214 illustrated in FIGS. 18-22 provides an air inlet near a bottom internal side of the ink reservoirs 235A-C. Further, the upper ends 254 of the air channels 250A-C are positioned near a top side of the housing and on external side surface of the housing 212. The air vent assembly/arrangement can be configured differently in other embodiments. For example, the air channels 250A-C can be defined within an interior side surface of the housing 212. For example, an air channel configured similar to the air duct 50 shown in FIGS. 6 and 14 could be included in each of the chambers 235A-C. The valves 252A-C can be positioned at other positions relative to an internal bottom surface of the reservoirs 235A-C such as along on the bottom surface or vertically higher on the sidewalls of the reservoirs 235A-C. Still further, chambers 262A-C and air channels 250A-C can be positioned on separate side walls of the housing 212. One or more of the air channels 250A-C can also be included in the cover 232. The position and structure of the air vent arrangement 214 can vary depending on, for example, the size and shape of the reservoirs 235A-C that results from the position and structure of partitions 231, 233. Many other alternative configurations and arrangements for the air vent arrangement 214, housing 212 and other features of the cartridge assembly 200 can result from application of the inventive principles disclosed herein.

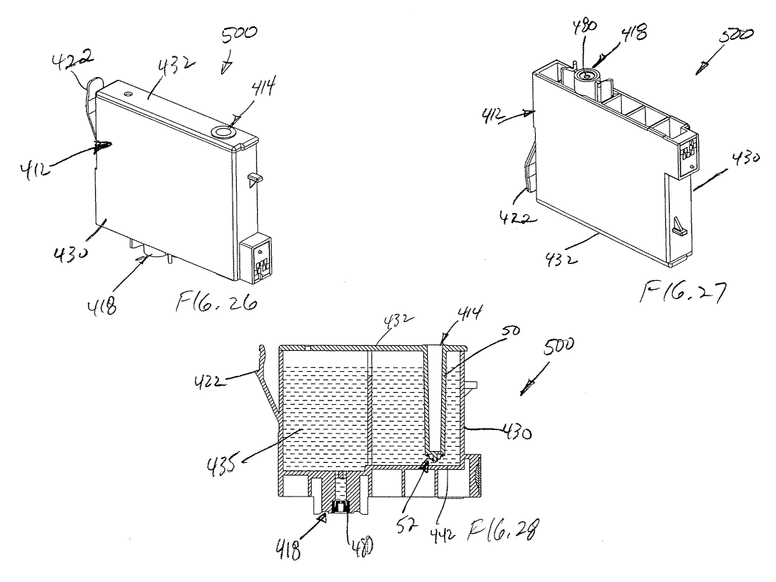

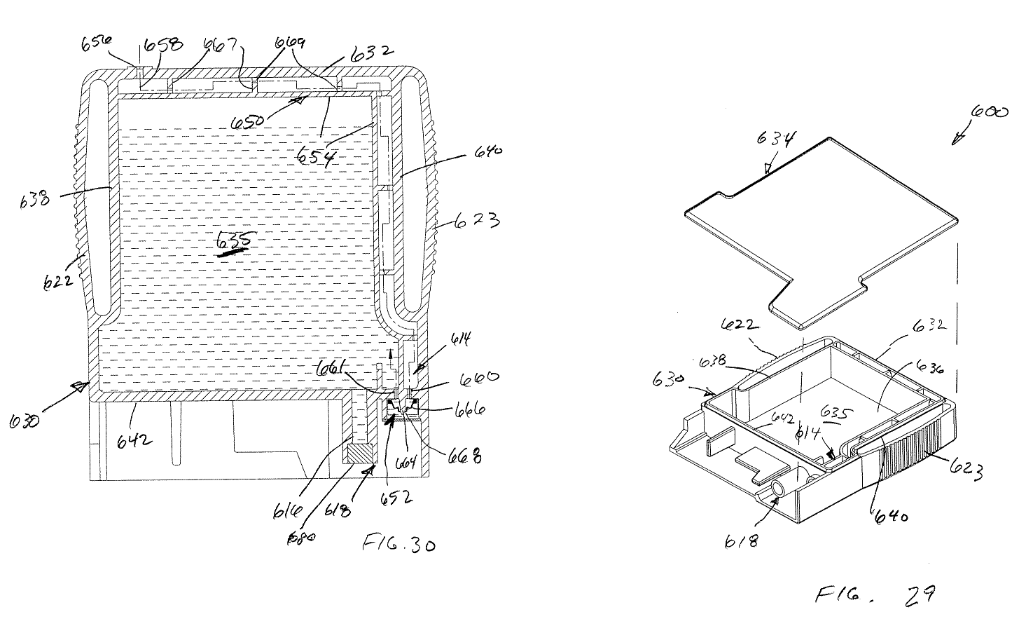

### EXAMPLES OF FIGS. 23-28

Referring now to FIGS. 23-28, example cartridge assemblies 400, 500 are shown and described. Each of the cartridge assemblies 400, 500 includes a housing 412, an air vent 414, an ink outlet 418, and a handle 422. The housing 412 includes a base 430 and a cover 432. The base 430 defines an ink reservoir 435.

The ink outlet 418 includes an ink aperture 484 that provides ink flow communication with the ink reservoir 435. A plug 480 is positioned in the ink aperture 484 to control the flow of ink from the ink reservoir 435 (see FIGS. 25, 28).

The air vent 414 provides a source of air to the ink reservoir 435 in a way that results in a negative pressure condition within the ink reservoir 435. Maintaining a negative pressure condition within the ink reservoir 435 is helpful for reducing incidence of unintentional dripping of ink from the ink outlet 418 before mounting the cartridge assemblies 400, 500 to a printer. The negative pressure condition also prohibits excessive ink outflow to the printer when the cartridge assemblies 400, 500 are mounted to a printer. Excessive ink outflow can cause dripping at the print head of the printer.

The air vent 414 can be constructed in accordance with the features described above with reference to air vent 14. The air vent 14 includes an air duct 50 and a valve 52. The air duct 50 is open to atmosphere air at an upper end along cover 432. The valve 52 acts as a one-way air valve to provide air at atmospheric pressure into the ink reservoir 435 near a bottom wall 442 of the body 430. The valve 52 remains in a closed, sealed state until a reduced pressure condition within the ink reservoir 35 greater than a threshold negative pressure opens the valve to permit air flow into the ink reservoir.

### EXAMPLES OF FIGS. 29-30

Referring now to FIGS. 29-30, an example cartridge assembly 600 is shown and described. The cartridge assembly 600 includes a base 630, a front cover 634, an air vent arrangement 614, an ink outlet 618, and a pair of handles 622, 623. The base 630 and front cover 634 define an ink reservoir 635. The base 630 includes a rear wall 636, first and second side walls 638, 640, and top and bottom walls 632, 642. The handles 622, 623 are positioned along the side walls 638, 640, respectively.

The ink outlet 618 is positioned along the bottom wall 642 and includes an ink channel 616 that provides ink flow communication with the ink reservoir 435. A plug 680 is positioned in the ink channel 616 to control the flow of ink from the ink reservoir 635.

The air vent assembly 614 provides a source of air to the ink reservoir 635. The configuration of he air vent assembly with an air inlet to the air vent assembly 613 positioned vertically above the level of ink in the ink reservoir 635 and an air inlet to the reservoir 635 at a bottom side of the ink reservoir helps maintain a negative pressure condition within the ink reservoir 635 before, during, and after removal of ink from the ink reservoir. Maintaining a negative pressure condition within the ink reservoir 635 is helpful for reducing incidence of unintentional dripping of ink from the ink outlet 618 before mounting the cartridge assembly 600 to a printer. The negative pressure condition also prohibits excessive ink outflow to the printer when the cartridge assembly 600 is mounted to a printer. Excessive ink outflow can cause dripping at the print head of the printer.

The air vent arrangement 614 includes an air channel 650 and a valve 652. The air channel 650 is defined by a channel wall 654 that extend along the top wall 632 and the side wall 640 between a channel air inlet 656 and the valve 652. A plurality of wall supports 667 extend between the channel wall 654 and the walls 632, 640. Each of the wall supports 667 includes a support opening 669 sized to permit air flow through the air channel 560 along an air flow path 658 (shown as a broken line in FIG. 30). The support openings 669 are offset at different sides of the wall supports 667 on adjacent wall supports 667. The offset arrangement of the support openings 669 reduces the chance of ink flowing through air channel 650 and out of the channel air inlet 656. A space in the air channel 650 defined between each of the adjacent wall supports 667 act as ink retaining chambers that hold any ink that may leak from the ink reservoir 635 into the air channel 650.

The valve 652 acts as a one-way air valve to provide air at atmospheric pressure into the ink reservoir 635 near a bottom wall 642 of the body 630. The valve 652 remains in a closed, sealed state until a reduced pressure condition within the ink reservoir 35 greater than a threshold negative pressure is generated. Once the threshold negative pressure condition is met or exceeded, the valve 652 opens to permit air flow into the ink reservoir. The increased negative pressure condition in the ink reservoir 635 is generated by drawing ink out of the ink outlet 618.

The valve 652 operates as a one-way air valve as follows. In a rest state, when the pressure condition in the ink reservoir 635 is below the threshold negative pressure level, a diaphragm 666 of the valve 652 engages a post 664, wherein the post 664 is engaged within a diaphragm opening 668. An inner side of the diaphragm 666 is exposed to atmospheric air conditions via the valve air inlet 660, air channel 650 and channel air inlet 656. An outer side of the diaphragm 666 is exposed to the pressure condition in the ink reservoir 635 via a valve outlet 661. When the threshold pressure condition in the ink reservoir 635 is met or exceeded, the diaphragm 666 is drawn away from the post 664, thereby permitting air to flow through the diaphragm opening 668 and into the ink reservoir 635 via the valve air outlet 661. When the negative pressure condition in the ink reservoir 635 reduces below the threshold pressure, the diaphragm 666 returns to the rest position in engagement with the post 664 to prevent ink from flowing into the air channel 650.

The air channel 650 of cartridge assembly 600 is shown in FIGS. 29-30 positioned within the base 630 and front cover 634 adjacent to the ink reservoir 635. Other arrangements can include positioning of the air channel 650 extending at least partially outside of the base 630 and cover 634 and spaced apart from the ink reservoir 635. Further, the air valve 614 is shown in FIGS. 29-30 extending at least partially below the bottom wall 642. In other arrangements, the air valve 614 can be positioned at other locations such as, for example, extending at least partially above the bottom wall 642 (e.g., see the position of valve 52 in FIGS. 25 and 28), or mounted to a side wall of the body 630. Further, in other arrangements, portions of the air channel 650 can have other shapes and configurations and still meet the desired result provided by the arrangement of FIGS. 29-30.

### SUMMARY AND CONCLUSION

An example method in accordance with principles of the present disclosure relates to determining an ink volume in the ink cartridge using the movable reflector. When the ink reservoir of the ink cartridge is filled with ink, the reflector floats away from a bottom internal surface of the ink reservoir. A light beam passed into the ink reservoir for reflection off of a reflective surface of the reflector dissipates in the ink and is not reflected back out of the ink cartridge. The reflector moves downward towards the bottom internal surface of the ink reservoir as ink is drawn out of the ink reservoir for use in a printer to which the ink cartridge is mounted. Eventually the reflector is positioned such that the light beam is able to reflect off of the reflective surface and out of the ink cartridge. The reflected light is collected and used to determine an ink volume in the ink cartridge.

Another aspect of the present disclosure relates to a printer ink cartridge that includes a housing defining an ink reservoir, and a light reflective member having a light reflective surface configured to reflect a beam of light. The light reflective member has a position in the ink reservoir that changes as an amount of ink in the ink reservoir changes. In one example, the light reflective member includes a concave surface that defines at least a portion of the light reflective surface.

A further aspect of the present disclosure relates to a printer ink cartridge that includes a housing having at least a bottom wall and a plurality of side walls that define an ink reservoir, and a light reflective member having a light reflective surface configured to reflect a beam of light. The light reflective member is positioned in the ink reservoir at a predetermined spaced apart location relative to the bottom wall of the housing. An amount of light reflected of from the light reflective surface changes as an amount of ink in the ink reservoir changes.

Another aspect of the present disclosure relates to the air vent. The printer ink cartridge includes a housing defining an ink reservoir containing ink, an ink outlet positioned on a bottom side of the housing, and an air vent extending from a top side of the housing into the ink reservoir. The air vent has a first end at a top side of the housing, a second end adjacent to an internal bottom surface of the ink reservoir, and a valve positioned at the second end. The first end is open to atmospheric air conditions. The valve includes a first air inlet in air flow communication with the open first end that permits air to flow into the ink reservoir automatically when a predetermined vacuum pressure condition exists in the ink reservoir and prohibits ink flow into the air vent. The valve can include a diaphragm, and the first air inlet is positioned centrally on the diaphragm.

A further aspect of the present disclosure relates to another air vent configuration for the ink cartridge. The ink cartridge includes a housing having opposing top and bottom walls and a plurality of side walls that together define an ink reservoir for holding a volume of ink. An ink outlet is positioned on the bottom wall of the housing. An air vent arrangement includes an air vent aperture formed in one of the plurality of side walls, an air valve positioned within the ink reservoir and having an air inlet in flow communication with the air vent aperture and an outlet in flow communication with the ink reservoir, and an air flow channel positioned along one of the side walls of the ink reservoir. The air flow channel has a first end in flow communication with the air vent aperture and a second end positioned above the air vent aperture.

The above specification provides examples of how certain inventive aspects may be put into practice. It will be appreciated that the inventive aspects can be practiced in other ways than those specifically shown without departing from the spirit and scope of the inventive aspects.

We claim:

1. A printer ink cartridge, comprising:
a housing defining an ink reservoir; and
a light reflective member having a light reflective surface configured to reflect a beam of light, the light reflective member having a position in the ink reservoir that changes as an amount of ink in the ink reservoir changes.

2. The ink cartridge of claim 1, wherein the light reflective member includes a concave surface that defines at least a portion of the light reflective surface.

3. The ink cartridge of claim 1, further comprising a channel member positioned in the ink reservoir and defining a path along which the light reflective member moves as the amount of ink changes in the ink reservoir.

4. The ink cartridge of claim 3, wherein the housing includes top, bottom and first and second side walls that define the ink reservoir, and the channel member extends from the top wall to the bottom wall of the housing.

5. The ink cartridge of claim 2, wherein the housing has a length, a width, and a height, the length being greater than the width, and an axis about which the concave surface curves extends parallel with the length of the housing.

6. The ink cartridge of claim 3, wherein the channel member that defines the path includes first and second spaced apart members extending inward from the housing walls.

7. The ink cartridge of claim 2, wherein the light reflective member includes a concave surface and a reflective material positioned on the concave surface that defines the concave reflective surface.

8. The ink cartridge of claim 2, wherein the concave reflective surface faces generally downward in the ink reservoir.

9. The ink cartridge of claim 1, wherein the light reflective member comprises a material having a density less than ink, whereby the light reflective member floats in ink contained in the ink reservoir.

10. The ink cartridge of claim 1, wherein the housing includes a window along a sidewall thereof in alignment with the light reflective member, the window configured to permit transmission of the beam of light into the ink reservoir.

11. A printer ink cartridge, comprising:
a housing having at least a bottom wall and a plurality of side walls that define an ink reservoir; and
a light reflective member having a light reflective surface configured to reflect a beam of light, the light reflective member positioned in the ink reservoir at a predetermined spaced apart location relative to the bottom wall of the housing, wherein an amount of light reflected of from the light reflective surface changes as an amount of ink in the ink reservoir changes.

12. A method of determining ink content in an ink cartridge, the ink cartridge including a housing that defines an ink reservoir containing ink, and a light reflective member movable within the ink reservoir, the method comprising steps of:
projecting a light beam into the ink reservoir through a wall of the housing; and
moving the light reflective member relative to the wall until the light beam reflects off from the light reflective member thereby indicating an amount of ink in the ink reservoir.

13. The method of claim 12, wherein the light reflective member floats in the ink, and moving the light reflective member includes removing ink from the ink cartridge to change a position of the light reflective relative to the wall.

14. The method of claim 13, wherein the light reflective member includes a concave reflective surface that reflects the light beam.

15. The method of claim 14, wherein the wall in a bottom wall of the housing, the wall including a light transmissive portion through which the light beam is projected.

16. A printer ink cartridge, comprising:
a housing defining an ink reservoir containing ink;
an ink outlet positioned on a bottom side of the housing; and
an air vent extending from a top side of the housing into the ink reservoir, the air vent having a first end at a top side of the housing, a second end adjacent to an internal bottom surface of the ink reservoir, and a valve positioned at the second end, the first end being open to atmospheric air conditions, the valve in air flow communication with the open first end, the valve configured to provide air flow into the ink reservoir automatically when a threshold negative pressure condition exists in the ink reservoir and prohibits ink flow into the air vent.

17. The ink cartridge of claim 16, wherein the valve includes a diaphragm and a first air inlet, the first air inlet positioned centrally on the diaphragm.

18. The ink cartridge of claim 17, wherein the valve includes a protrusion that is extendable through the first air inlet, and the threshold negative pressure condition draws the diaphragm away from the protrusion to permit air to flow through the first air inlet into the ink reservoir.

19. The ink cartridge of claim 16, further comprising a light reflective member having a light reflective surface configured to reflect a beam of light, the light reflective member having a position in the ink reservoir that changes as an amount of ink in the ink reservoir changes.

20. The ink cartridge of claim 16, wherein the valve is positioned no greater than about 5 mm vertically above to the internal bottom surface of the ink reservoir.

21. An ink cartridge, comprising:
a housing including opposing top and bottom walls and a plurality of side walls that together define an ink reservoir for holding a volume of ink;
an ink outlet positioned on the bottom wall of the housing; and
an air vent arrangement including an air vent aperture formed in one of the plurality of side walls or the top wall of the housing, an air valve exposed to ink in the ink reservoir and having an air outlet in flow communication with the ink reservoir, and an air flow channel positioned along one of the side walls of the ink reservoir, the air flow channel in flow communication with the air vent aperture and the air valve, the air valve positioned adjacent the bottom wall of the housing.

22. The ink cartridge of claim 21, wherein the air flow channel is defined in part by one of the plurality of sidewalls of the housing.

23. The ink cartridge of claim 21, wherein the air valve is configured as a one-way valve that permits air to be drawn into the ink reservoir when a threshold negative pressure condition exists in the ink reservoir.

24. The ink cartridge of claim 21, wherein the housing includes at least three ink reservoirs and a separate air vent arrangement associated with each of the ink reservoirs.
